(19) United States
(12) Patent Application Publication
(10) Pub. No.: US 2015/0294220 A1
(43) Pub. Date: Oct. 15, 2015

(54) STRUCTURING DATA AROUND A TOPICAL MATTER AND A.I./N.L.P./ MACHINE LEARNING KNOWLEDGE SYSTEM THAT ENHANCES SOURCE CONTENT BY IDENTIFYING CONTENT TOPICS AND KEYWORDS AND INTEGRATING ASSOCIATED/RELATED CONTENTS

(71) Applicant: KHALID RAGAEI OREIF, PACIFIC PALISADES, CA (US)

(72) Inventor: KHALID RAGAEI OREIF, PACIFIC PALISADES, CA (US)

(21) Appl. No.: 14/251,447

(22) Filed: Apr. 11, 2014

(51) Int. Cl. G06N 5/04; G06F 3/0484; H04L 29/06; G06F 3/0481; G06N 99/00; G06F 17/30

(52) U.S. Cl. CPC G06N 5/04; G06N 99/005; G06F 17/30554; H04L 67/42; G06F 3/04817; G06F 3/04842

(57) ABSTRACT

A data structuring and artificial intelligence (AI), natural language processing (NLP) and Machine Learning knowledge system that enhances source content by identifying content topics and keywords and integrating associated and related internal and external content along with extracted information such as summaries, conclusions, action items, time sensitive topics, etc., is disclosed. The data structuring and AI/NLP/Machine Learning knowledge system includes an intelligent document viewer system and a communication sub-system with an objective communication system, an objective calendar communication system, and voice commands/responses system.

### BACKGROUND

Embodiments of the invention described in this specification relate generally to topical content systems, and more particularly, to systems and methods for identifying topics and keywords in content items and associating/clustering the content with other content related to the topic and/or keywords to present a structured view of the content around a topical matter.

Business communications today is cumbersome. Generally, there is no automatic identification of key terms in documents/email/calendar events such as people, companies, terms, etc. Important information and action items are hard to follow in emails, notes, documents and invites. Email and calendars occupy a central role in our workplace, yet they are very primitive and traditional in many aspects. People typically are required to dig into large volume of unstructured data on a daily basis to come up with the most up to date information, tasks, and/or conclusions in relation to one or more topics. Also, emails, calendars, and documents are not integrated with useful data sources to show participants' profiles, companies' profiles, news, wild, etc. In short, there is a lack of tools for people to use in aggregating and/or summarizing the data and presenting up to date information structured around a topical matter or event.

Therefore, what is needed is a way to highlight, display, and/or link to important terms in content items (e.g., in an email, calendar event or generally a document), including people, places, companies, and terms, and also a way to structure the data around one or more topical matter or events by leveraging AI/NLP/Machine Learning to analyze, summarize, and organize data, including emails, instant communication logs, agenda topics, meeting notes, and generally documents. The analyzed data is combined with attendee profiles including pictures, terms, company profiles, maps data, relevant wiki information and time zone converters to be presented in a structured way around the topical matter offering summary and conclusions, time sensitive material, action items, latest attachments, latest news and updates based on time lines. The user can also listen and interact through voice commands.

### BRIEF DESCRIPTION

Some embodiments of the invention include a novel data structuring around a topic or event, artificial intelligence (AI), natural language processing (NLP), and machine learning knowledge system that enhances source content by integrating related content using keywords and structuring it around a topical matter offering structured view and user interface organized by topics or events.

In some embodiments, the data structuring and AI/NLP/Machine Learning knowledge system includes an intelligent document viewer system and a communication sub-system with an objective communication viewer system, an objective communication calendar system and a voice based command/response system.

In some embodiments, the processes are implemented as a software applications and/or modules of software applications which run on a processing unit of a computing device.

In some embodiments, the intelligent document viewer is a client/server software application that allows a user to view a set of content items from one or more content sources that are related to content items through keywords.

In some embodiments, the objective communication system includes an objective communication viewer, objective communication calendar analyzer, objective communication AI/NLP/Machine Learning algorithms, and voice commands/responses natural language interface.

In some embodiments, the objective communication system is a set of client/server software application modules that allows a user to view a set of content items from one or more content sources that are related to content items through a topical matter. In some embodiments, the user can navigate and interact with the content items through a user interface.

In some embodiments, the objective communication system has client/server software application module that allows a user to give voice commands and get voice responses as an alternative interaction method for viewing and navigating through the user interface.

The preceding Summary is intended to serve as a brief introduction to some embodiments of the invention. It is not meant to be an introduction or overview of all-inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of a data structuring and AI/NLP/Machine Learning knowledge system in some embodiments.

FIG. 2 conceptually illustrates a flow diagram of a document viewer process performed by a data structuring and AI/NLP/Machine Learning knowledge system in some embodiments.

FIG. 3 conceptually illustrates a flow diagram of a communication module of a data structuring and AI/NLP/Machine Learning knowledge system in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel data structuring around a topic or event, artificial intelligence (AI), natural language processing (NLP), and machine learning knowledge system that enhances source content and structure it around a topical matter by using keyword taggers, clustering, incremental clustering, unsupervised machine learning, identifying topics, supervised machine learning, identifying topics based on optional hash tags, sematic analysis to extract conclusions and action items, and integrating associated content from various data sources.

In some embodiments, the data structuring and AI/NLP/Machine Learning knowledge system includes an intelligent document viewer system and communication sub-system with an objective communication viewer, an objective communication calendar system, an objective communication AI/NLP/Machine Learning algorithms, and voice commands/responses natural language interface.

As stated above, business communications today is cumbersome. There is no automatic identification of key terms in documents/email/calendar events such as people, companies, terms, etc. Important information and action items are hard to follow in emails, notes, documents and invites. Email and calendars occupy a central role in our workplace, yet they are very primitive and traditional. People have to dig into large volume of unstructured data on daily basis to come up with most up to date information, tasks and conclusions. Emails/Calendar and Documents are not integrated with useful data sources to show participants' profiles, companies' profiles, news, wiki, etc. There are no tools for aggregating/summarizing the data and presenting up to date information structured around a topical matter.

Embodiments of intelligent keyword extraction, data structuring/clustering around a topical matter and AI/NLP/machine learning knowledge system described in this specification solve such problems by a process for highlighting important terms (in an email, calendar event, or generally in a document) such as people, places, companies, terms and display/link to relevant information. The data structuring and AI/NLP/Machine Learning knowledge system of some embodiments also includes a process for structuring/clustering data around topical matters. In some embodiments, the data structuring and AI/NLP/Machine Learning knowledge system includes a set of processes for leveraging artificial intelligence (AI)/natural language processing (NLP) based on machine learning to analyze, summarize, and organize data, including emails, instant communication logs, agenda topics, meeting notes, and generally documents. In some embodiments. The analyzed data is combined with attendee profiles including pictures, terms, company profiles, maps data, relevant wiki information and time zone converters to be presented in a structured way around the topic showing summary and conclusions, time sensitive materials, action items, latest attachments, latest news and updates based on a timeline. In some embodiments, the data structuring and AI/NLP/Machine Learning knowledge system includes processes for integrating with popular calendars, email clients and document processing software. In some embodiments, the user can listen and interact through voice commands.

In some embodiments, the processes are implemented as a software applications and/or modules of software applications which run on a processing unit of a computing device. In some embodiments, the intelligent document viewer software application is a client/server application that allows a user to view a set of content items from one or more content sources that are related to keywords of a particular content document item. In some embodiments, the objective communication system includes an objective communication viewer, objective communication calendar analyzer, objective communication AI/NLP/Machine Learning algorithms, and voice commands/responses natural language interface. In some embodiments, the objective communication system includes tree structure of topics and subtopics, document analyzer (email handler, calendar handler, etc.), incremental clustering, unsupervised machine learning (build a cluster from a subset of documents and extract topics), supervised machine learning (identify topics potentially based on optional hash tags and build clusters around the topics), sematic analysis to extract conclusions, action items, etc. In some embodiments, the objective communication calendar system includes an objective communication calendar analyzer.

In some embodiments, the data structuring and AI/NLP/Machine Learning knowledge system includes a server that performs a set of server-side processes that are implemented as server applications and/or modules. In some embodiments, the server includes server application with a noise extractor module, canonicalization module with synonyms/dictionaries, a plurality of keyword extractor modules with & without storage, a plurality of entity recognition tagger modules with & without storage, a negative entities algorithm and dictionary module, a tagger merger and refiner module that weight the results from the entity recognition taggers & keyword extractors and is trained based on industry/community specific training data and ongoing users feedback, and a response wrapper/packer module.

In some embodiments, the data structuring and AI/NLP/Machine Learning knowledge system uses the software application and software modules to perform each process that (i) analyzes content items (e.g., emails/documents/calendar events) in search of key terms, people, places, companies, and other important terms to highlight in the content items, (ii) analyzes calendar events and emails and any unstructured data using an AI/NLP/Machine Learning algorithms, (iii) uses optional hashtags to analyze emails and unstructured data, (iv) clusters the data around a topic or event and presents/displays the analyzed data in a structured/organized form, show the cumulative view of the data around a topical matter while it allows seeing different snapshot based on a timeline, in some embodiments, presenting or displaying with color codes, (v) in some embodiments, provides an audio summary of the event/topic with relevant information, (vi) provides inline action buttons to facilitate execution and follow-ups, (vii) keeps track of all contacts and preferred ways of communication for each one such as email, IM, etc., (viii) facilitates, logs, and keeps track of all communications, (ix) uses optional hashtags to link and display multimedia attachments, images, and video inline in the relevant spot, (x) encourages peer-to-peer communication while sharing the results as conclusions and action items, and (xi) allows/prompts you to participate virtually in discussion and join meetings with a click of button or a voice command.

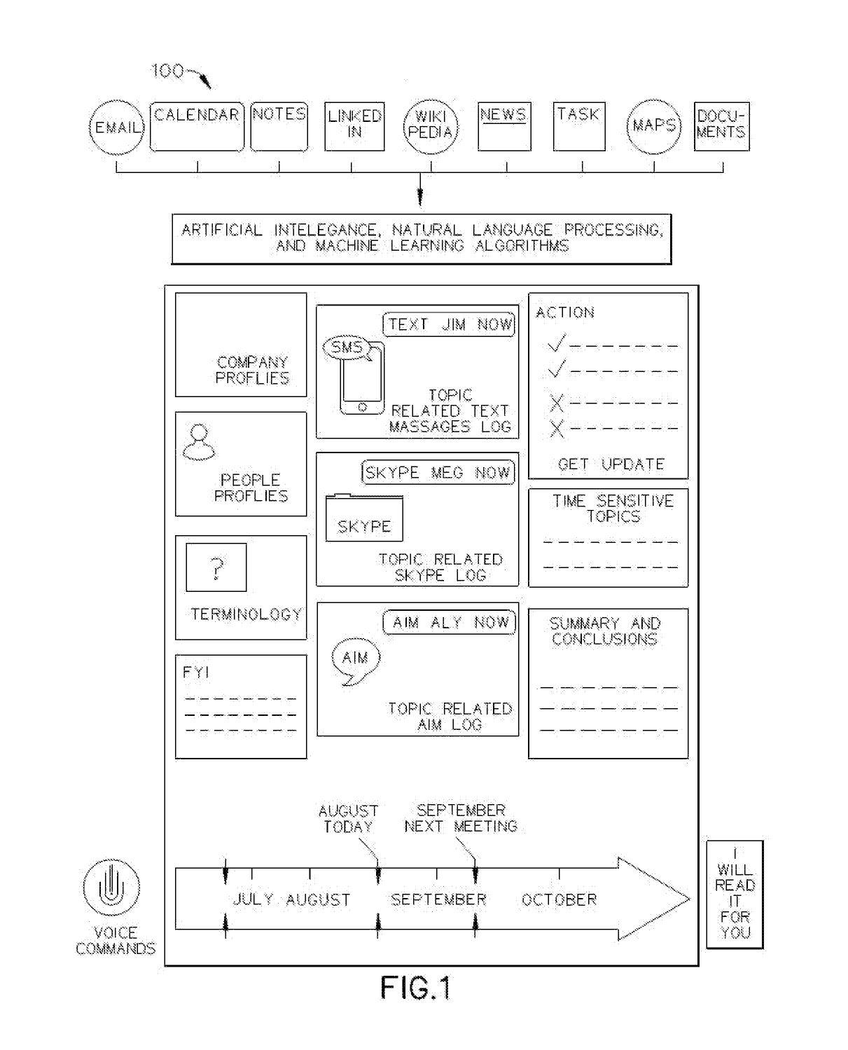

By way of example, FIG. 1 conceptually illustrates a schematic view of a data structuring and AI/NLP/Machine Learning Knowledge system 100 in some embodiments. As shown in this figure, the data structuring and AI/NLP/Machine Learning knowledge system 100 starts with a variety of source content items, including email, calendar, notes, LinkedIn (externally sourced information), Wikipedia (externally and in some cases, custom-built external or internal wilds), news, tasks, maps, and documents in any of several formats, including word processing documents, spreadsheet documents, database reports, etc. The content items are available to the AI/NLP Machine Learning sub-system to perform natural language processing (NLP) and sematic analysis on the content to identify topics, conclusions and matters of importance. A client/server application is used to display the data structured around an event or a topic. This client/server application is accessible from inside other applications such as email or calendar system, or it could be a stand-alone application. This example shows that a number of related content items structured around a topical matter including email, calendar, notes, FYI, SMS text messages, online streamed messaging logs (e.g., Skype, AIM, etc.), action item lists, time sensitive items, summaries & conclusions, and a time line. All the content items could reference or link to the original content such as the email that an action item was driven from. Different snapshots of the data structured around an event or topic, are displayed based on the user interacting with the timeline at the bottom of the diagram. The document viewer is the client/server application that presents the enhanced information on any content item, event or topic. This example shows that a number of related content items are displayed, including company profiles, people profiles and terms. As shown, the client software user can interact with the user interface or provide voice commands, which in some embodiments are received by the data structuring and AI/NLP/Machine Learning knowledge system 100 and processed accordingly. Additionally, the data structuring and AI/NLP/Machine Learning knowledge system 100 can provide hands-free operation in which items are read back to the user. For example, the user may be in the car using a mobile computing and communication device, such as a smart phone, and may be reviewing emails by using the document viewer of the data structuring and AI/NLP/Machine Learning knowledge system 100 to also review important related content items, which can be read out by the system as the user is driving the vehicle.

The embodiments of the data structuring and AI/NLP/Machine Learning knowledge system described in this specification differ from and improve upon currently existing systems or options. In particular, some embodiments of the data structuring and AI/NLP/Machine Learning knowledge system differ from other systems because the existing tools available in the existing systems, such as email client applications, do not structure the data around a topical matter (e.g., topic or event), and do not look up relevant information from other relevant data sources such as Wikipedia (e.g., external source content) or documents and calendars (e.g., internal source content). The data in email clients is unstructured. A person cannot just peek at an email message and instantly identify all relationship with other emails, other documents, various electronic discussions related to that topical matter, time sensitive material, action items, follow ups, etc. The person can't also instantly identify the progress over time, names, places, companies, and important terms. Instead, such a person would need to manually dig into large volumes of unstructured data (documents, calendars, external sources, etc.) on a daily basis to come up with the most up to date information, tasks, and conclusions that may be related to one or more topical matters in the corresponding email (and likewise if the content item was a document, a message, etc.). The existing systems and options also are not integrated with useful data sources such as participants' profiles, company profiles, news, wiki, etc.

In addition, the data structuring and AI/NLP/Machine Learning knowledge system of some embodiments improves upon the currently existing systems and/or options because none of the existing email systems or applications, calendars (both proprietary and public calendars), and document applications (e.g., readers and editors) are intelligent. Nor are the existing systems integrated with useful data sources such as participant profiles, company profiles, news, wiki, etc. In contrast, the data structuring and AI/NLP/Machine Learning knowledge system of some embodiments highlights the important terms (in an email, calendar event, or generally a document) such as people, places, companies, terms and displays/links to relevant information. The data structuring and AI/NLP/Machine Learning knowledge system also structures the data around topical matters. In doing so, the data structuring and AI/NLP/Machine Learning knowledge system of some embodiments leverages AI/NLP based on machine learning to analyze, summarize and organize data, such as agenda topics, email messages, meeting notes, attachments, attendee profiles (including pictures), company profiles, terms, latest news and updates, relevant wiki information, and/or time lines associated with that topical matter.

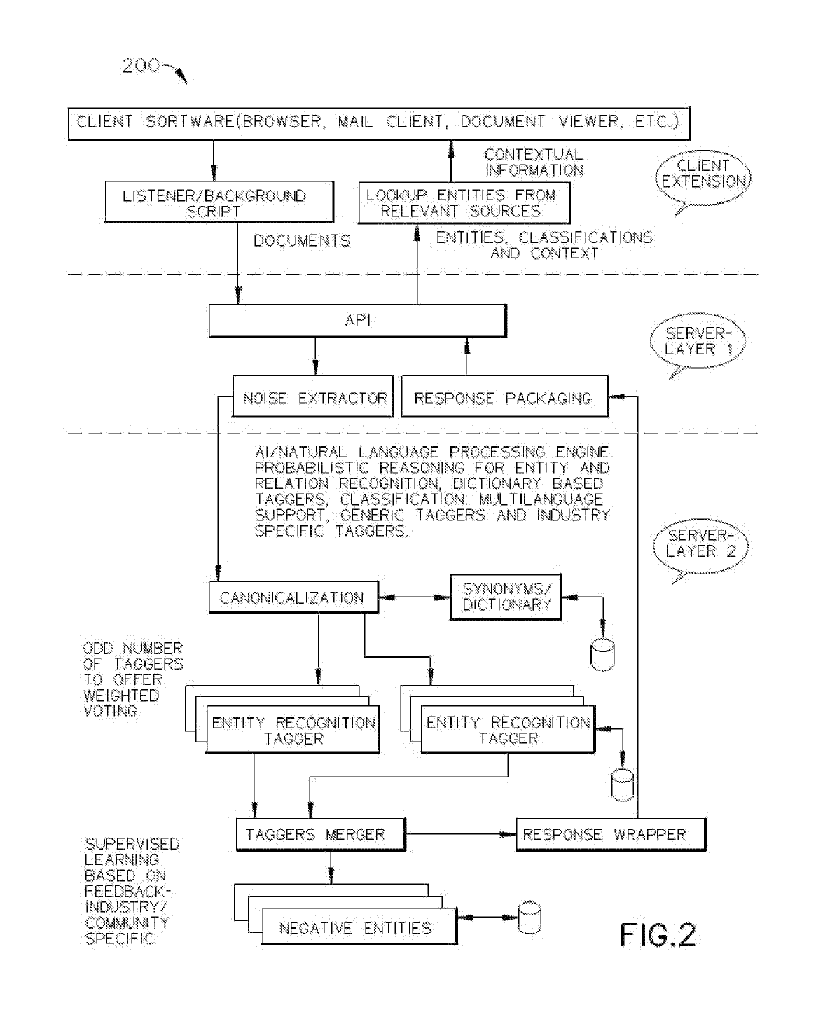

By way of example, FIG. 2 conceptually illustrates a flow diagram of a document viewer process performed by a data structuring and AI/NLP/Machine Learning knowledge system 200 in some embodiments. As shown in this figure, the data structuring and AI/NLP/Machine Learning knowledge system 200 may be comprised of the following elements. This list of possible constituent elements is intended to be exemplary only and it is not intended that this list be used to limit the data structuring and AI/NLP/Machine Learning knowledge system of the present application to just these elements. Because FIG. 2 presents one example of a data structuring and AI knowledge system, persons having ordinary skill in the art relevant to the present disclosure may understand there to be equivalent elements that may be substituted within the present disclosure without changing the essential function or operation of the data structuring and AI/NLP/Machine Learning knowledge system.

1. Client software sends a document (e.g., email or calendar item) to the server.

2. The server runs an application that cleans the document object through a noise extractor module to remove markup language and other non-content oriented items (i.e., noise).

3. The server application passes the clean document to canonicalization module that is associated with synonyms/dictionary to do some translations if needed.

The server application passes the clean/canonical document to entity recognition taggers to extract and vote on keywords. Some Taggers could have dictionary.

4. A tagger merger/refiner module uses the results from the entity recognition taggers and keyword extractors, industry/community specific training data, public data sources, and ongoing users feedback to decide about the keywords and the recommended categories.

5. The server application sends the keywords and their recommended categories to the client software.

6. The client software identifies each keyword based on the recommended category.

7. When the category is a company, the client software identifies the company details from public websites and data sources (e.g., Freebase, Crunchbase, Wikipedia, etc.).

8. When the category is a person, the client software searches for and retrieves the person details from public websites and data sources (e.g., LinkedIn, Wikipedia, etc.).

9. When the category is a term, the client software retrieves the term details from public websites and data sources (e.g., Wikipedia, Google, etc.).

10. When the category is a place, the client software searches for the place on public mapping (e.g., Google Maps, here.com, etc.). The client software also show it along with preferred location (home place)

11. When the category is date, the client software displays the calendar.

12. In case of a time displayed in specific time zone on a document, the client software converts it to the preferred time zone (home time zone).

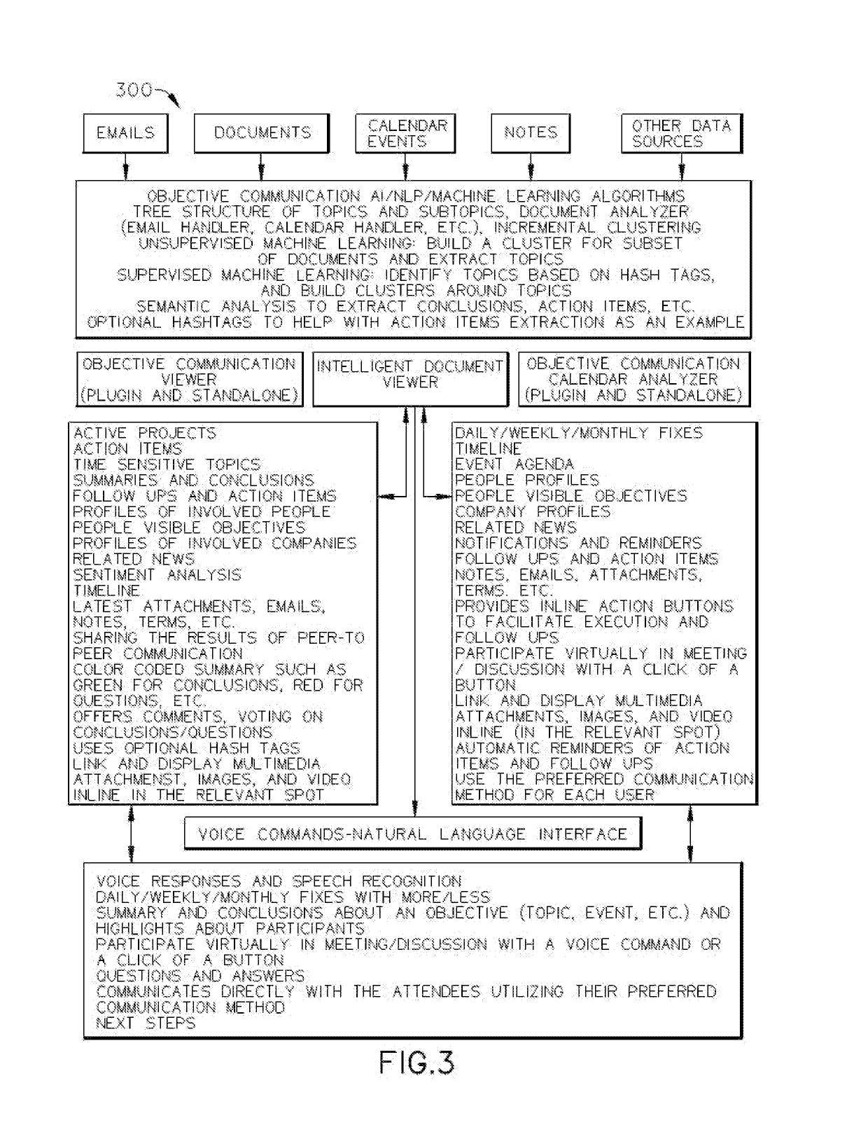

By way of example, FIG. 3 conceptually illustrates a flow diagram of the communication modules 300 of the data structuring and AI/NLP/Machine Learning knowledge system. Specifically, this figure shows the objective communication system, with associated objective communication viewer and objective communication AI/NLP/Machine Learning algorithms. Also shown are the objective communication calendar analyzer and Voice Commands/Reponses. Both the objective communication system and objective communication calendar analyzer use the intelligent document viewer of the client/server software application.

13. The email/event/document client/viewer has an icon to show the associated objective communication view (and which could also run as a stand-alone client application).

14. Clicking on that icon shows the structured objective communication viewer including active projects, cumulative action items, time sensitive topics, summaries & conclusions, follow ups and action items, profile of involved people, people visible objectives, profiles of involved companies, related news, sentiment analysis, latest attachments, emails, notes, terms, peer-to-peer communication logs, and time-line. In some embodiments, color-coded summaries such as green for conclusions, red for questions, etc. are used.

15. Module 300 AI/NLP Machine Learning algorithms analyze documents/emails/events and structures it based on a topic/event/objective. This includes tree structures of topics and subtopics, document Analyzer (email handler, calendar handler, etc.), incremental clustering, unsupervised machine learning (Building a cluster for a subset of documents and extract topics), supervised machine learning (identify topics potentially based on hashtags and build a cluster around each topic, sematic analysis to extract summary, conclusions, and action items. Optional Hashtags action item extraction as an example.

16. Interacting with the time-line causes the objective communication viewer to highlight known items at that time.

17. Module 300 can also interact and respond via voice commands and provide voice based information such as daily/weekly/monthly fix with more/less, summary and conclusions about a topical matter, highlights about participants, participate virtually in a meeting with a voice command, questions/answers, knowledge about acronyms/keywords used, notifications, follow-ups and reminders.

18. Module 300 also accepts commands (including voice commands) such as to increase or reduce information about a specific item, communicates directly with the attendees utilizing their preferred communication method and logs the communication to the topic/event.

19. Module 300 in some embodiments also analyzes a calendar and provides a daily/weekly/monthly fix along with information about each calendar item, such as conclusions about an objective/topic, highlights about participants, knowledge about acronyms/keywords used, notifications, as well as follow-ups and reminders.

20. Hashtags used in the subject line or the body/document could be used optionally to help with AI/NLP/Machine Learning.

21. Commenting and voting on conclusions and questions.

The data structuring and AI/NLP/Machine Learning knowledge system of the present disclosure generally works by performing a set of processes, each of which is implemented in some embodiments as software applications and/or modules of a software application. In particular, at least three working aspects of the data structuring and AI/NLP/Machine Learning knowledge system include the “Intelligent Document Viewer”, the “Objective Communication Viewer”, the “Voice Commands/Reponses—Natural Language Interface”, and the “Objective Communication Calendar Analyzer”, and are described as follows.

1. “Intelligent Document Viewer” is self-sufficient and used as an enhanced AI/NLP/Machine Learning email/webpage/document viewer that highlights keywords (e.g., persons, companies, topics, etc.) and provides inline additional information from multiple trusted sources (e.g., Wikipedia, LinkedIn, Crunchbase, Freebase, Google News, etc.). This could run standalone on any type of computing device (e.g., PC, mobile computing and/or communication device, tablet computing device, etc.).

2. “The Objective Communication System” includes the “Objective Communication Viewer” which is standalone software or linkable from existing information viewers, “The Objective Communication Calendar Analyzer” and “Objective Communication AI/NLP/Machine Learning Algorithms” work together and uses the “Intelligent Document Viewer” and “Voice Commands/Responses—Natural Language Interface” to structure the data and show it around a topical matter including cumulative action items, time sensitive topics, summaries & conclusions, follow ups and action items, profile of involved people, people visible objectives, profiles of involved companies, related news, sentiment analysis, latest attachments, emails, notes, terms, peer-to-peer communication logs, and time-line. In some embodiments, color-coded summaries such as green for conclusions, red for questions, etc. are used.

3. The “The Objective Communication Calendar Analyzer” is also used along with “Intelligent Document Viewer” and Voice Commands/Responses—Natural Language Interface” to offer daily fix about events, participants, companies and acronyms.

To use the data structuring and AI/NLP/Machine Learning knowledge system of the present disclosure, people could take parts and develop software on computers, laptops, mobile devices and tablets to do that, or in some cases, it could be embedded as a plug-in for applications and systems such as word processing, excel, email clients, mobile email clients and word processing, etc.

To make the data structuring and AI/NLP/Machine Learning knowledge system of the present disclosure, a person would need to make processes that a user of the data structuring and AI/NLP/Machine Learning knowledge system can perform on one or more computing devices. Many of the above-described processes, modules, features, and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic or optical storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

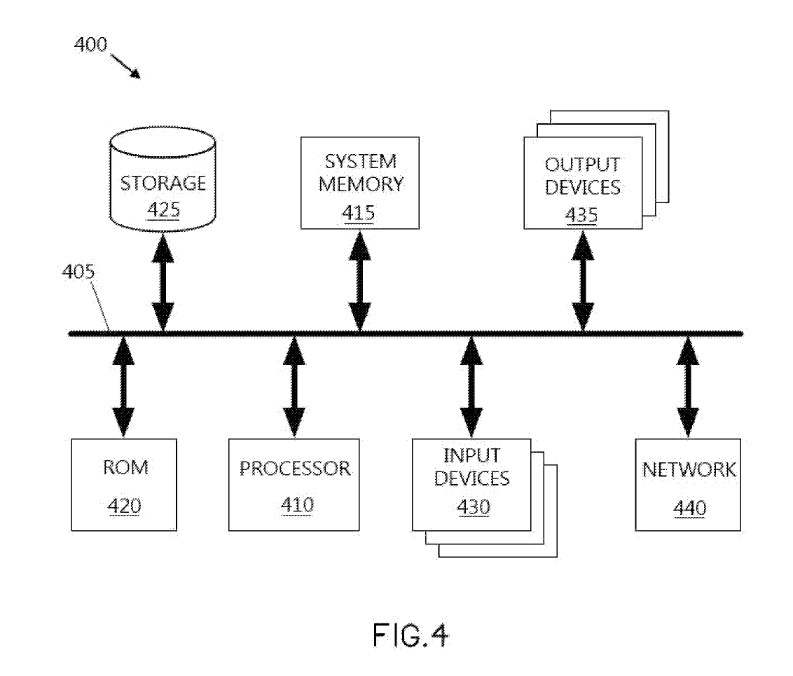

FIG. 4 conceptually illustrates an electronic system 400 with which some embodiments of the invention are implemented. The electronic system 400 may be a computer, phone, PDA, or any other sort of electronic device. Such an electronic system includes various types of computer readable media and interfaces for various other types of computer readable media. Electronic system 400 includes a bus 405, processing unit(s) 410, a system memory 415, a read-only 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a floppy disk or a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. For example, the various memory units include instructions for processing appearance alterations of displayable characters in accordance with some embodiments. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as cathode ray tubes (CRT) or liquid crystal displays (LCD). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet). Any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, some of the figures conceptually illustrate processes. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A data structuring, artificial intelligence (AI), natural language processing (NLP), and machine learning knowledge system that enhances source content by identifying content keywords and topics and integrating associated/related content, said system comprising:
a client computing device comprising a processor, a memory unit, a display screen, and an intelligent document viewer application which when running on the processor and communicating with the server, highlights a set of keywords in the source content and show on the display screen people's profiles, pictures, companies' profiles, terms, maps, news, social media items, and other context relevant information, when the user mouse over the keywords; and
a server computing device comprising a server application with a noise extractor module, canonicalization module with synonyms/dictionaries, a plurality of keyword extractor modules with and without storage, a plurality of entity recognition tagger modules with and without storage, a negative entities algorithm and dictionary module, a tagger merger and refiner module that weight the results from the entity recognition taggers & keyword extractors and is trained based on industry/community specific training data and ongoing users feedback, and a response wrapper/packer module that returns a highly relevant set of keywords to a user of the client computing device running the intelligent document view application.

2. The data structuring and AI/NLP/Machine Learning knowledge system of claim 1, wherein the set of AI/NLP/Machine Learning modules further analyze content items to cluster contents around a topical matter, use incremental clustering as needed, conduct unsupervised machine leanings and supervised machine learning with hash tags and other techniques, perform semantic analysis to extract conclusions and various items such as action items to facilitate displaying the content items along with the extracted information in a structured fashion around the topical matter and present it visually and through audio to the user allowing interactions through the user interface or voice commands.

3. The data structuring and AI/NLP/Machine Learning knowledge system of claim 2, wherein the set of content items comprises a set of email messages, a set of calendar events, a set of notes, a set of social media items, a set of public knowledge source articles, a set of news items, a set of text messages, a set of tasks, a set of maps, and a set of documents.

4. The data structuring and AI/NLP/Machine Learning knowledge system of claim 1 and claim 2 further comprising a voice response and speech recognition sub-system that interprets audible vocalizations of a user of the client computing device and provides audible feedback regarding the topical matter and associated content items, related content, and the extracted information.

5. A non-transitory computer readable medium storing a program which when executed by at least one processing unit of a computing device offer an icon to show the user a structured view of this source content item along with other related content items based on the topical matter, said program comprising sets of instructions for:
displaying the content source item; and
displaying cumulative snapshot based on a point in time of conclusions, action items, time sensitive items, summaries, fyi items, people involved, companies involved, terminologies, source contents such as email, calendar items, notes, documents and text messaging logs.

6. The non-transitory computer readable medium of claim 5 further comprising a set of instructions for identifying the set of keywords in the displayed content source item.

7. The non-transitory computer readable medium of claim 6, wherein the set of instructions for identifying the set of keywords comprises a set of instructions for searching the internal and external content of the displayed content source item for one or more of a name of a person, a name of a company, a timing item, a name of a location, and a date.

8. The non-transitory computer readable medium of claim 5, wherein the set of associated and related content source items comprises at least one of a set of email messages, a set of calendar events, a set of notes, a set of social media items, a set of public knowledge source articles, a set of news items, a set of text messages, a set of tasks, a set of maps, and a set of documents.

9. The non-transitory computer readable medium of claim 5, wherein the program further comprises sets of instructions for using an objective communication viewer and an objective communication calendar analyzer.

10. The non-transitory computer readable medium of claim 5, wherein the set of instructions for highlighting comprises a set of instructions for color coding different types of topical items in the set of topical items along with extracted information such as action items, time sensitive items, etc.
